(19) United States
(12) Patent Application Publication
(10) Pub. No.: US 2008/0085169 A1
(43) Pub. Date: Apr. 10, 2008

(54) Anchoring Arrangement and Use of an Anchor Rod

(75) Inventors: Juergen Gruen, Boetzingen (DE); Martin Vogel, Glottertal (DE); Joachim Schaetzle, Kenzingen (DE); Reinhold Pfaff, Denzlingen (DE)

Correspondence Address: MICHAEL J. STRIKER, 103 EAST NECK ROAD, HUNTINGTON, NY, 11743, US

(73) Assignee: FISCHERWERKE ARTUR FISCHER GMBH & CO. KG, Waldachtal (DE)

(21) Appl. No.: 11/576,164

(22) PCT Filed: Oct. 18, 2005
(86) PCT No.: PCT/EP05/11160

§ 371 Date: Mar. 28, 2007

(30) Foreign Application Priority Data
Oct. 29, 2004 (DE) 10 2004 052 570.6

(51) Int. Cl. F16B 13/06; F16B 33/00

(52) U.S. Cl. 411/44; 411/386

(57) ABSTRACT

The invention relates to an anchoring arrangement (1) having an anchor rod (2) which is anchored with mortar (3) in a bore (4) in an anchoring substrate (5) (concrete). The anchoring arrangement (1) is crack-resistant when the following conditions are fulfilled:

$$\begin{matrix}\frac{bore diameter}{diameter of anchor rod} * bond stress \geq 14 \frac{N}{{mm}^{2}} \\ and & ( I ) \\ 0.4 \leq \frac{diameter of anchor rod}{bore diameter} \leq 0.85 . & ( II )\end{matrix}$$

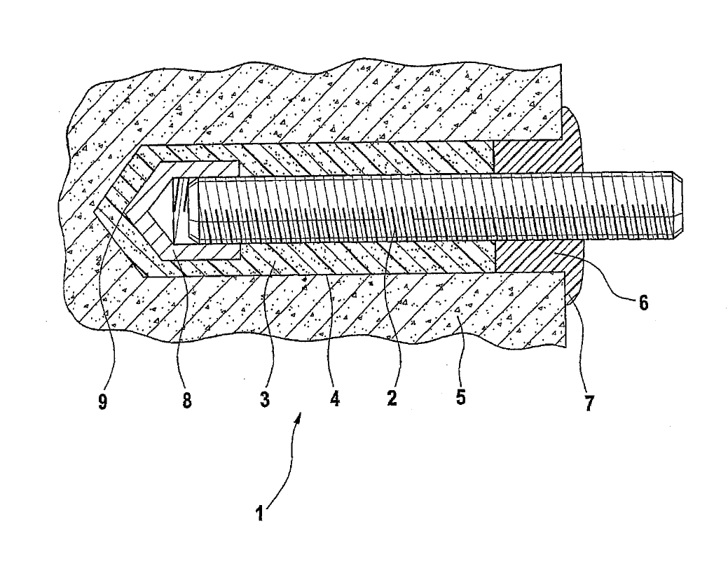

The invention relates to an anchoring arrangement having the features of the preamble of claim 1 and to the use of an anchor rod having the features of the preamble of claim 8.

Anchoring arrangements in which an anchor rod is anchored with mortar in a bore in an anchoring substrate are known. The anchoring substrate is, for example, a piece of masonry or a concrete or concrete-covered building component or structure. The term “bore” is to be understood generally as meaning a hole in an anchoring substrate, irrespective of the way in which it has been made. One-component or multi-component synthetic resin mortars are often used as mortar. The term “mortar” is here to be understood generally as meaning hardenable compositions. An article can be fixed to the anchor rod anchored in the anchoring substrate. For a crack-resistant anchoring, special anchor rods are required. “Crack-resistant” means resistance in respect of possible widening of the bore caused by the formation of cracks in the anchoring substrate. Cracks can form especially in a tension zone of the anchoring substrate, that is to say on the underside of a ceiling, a bridge or a beam. For that purpose, anchor rods are known that have a number of truncated cones arranged axially one after the other in an anchoring portion. The anchoring portion of the anchor rod is the portion of the anchor rod located in the bore and surrounded by mortar. The truncated cones are preferably formed integrally with one another and are an integral component of the anchor rod. In the event of tensile stress being exerted on the anchor rod and the bore's becoming wider, the anchor rod moves a short way axially out of the bore and in so doing displaces the truncated cones which act as expander bodies and press the mortar surrounding them outwards. The mortar is widened or expanded, so that the anchor rod remains anchored in the anchoring substrate. An anchoring device is here regarded as being crack-resistant when the failure load achievable in a cracked anchoring substrate (0.5 mm crack) is at least 80% of the load at which the anchoring arrangement fails in an uncracked anchoring substrate; in some cases test guidelines require the 80% criterion only in respect of a comparison between failure in the case of a 0.5 mm crack and in the case of a 0.3 mm crack.

The problem underlying the invention is to propose a crack-resistant anchoring arrangement using mortar that does not require a special anchor rod.

That problem is solved according to the invention by the features of claim 1 and claim 8. The anchoring arrangement according to the invention fulfils the two conditions:

$$\begin{matrix}\frac{bore diameter}{diameter of anchor rod} * bond stress \geq 14 \frac{N}{{mm}^{2}} \\ and & ( I ) \\ 0.4 \leq \frac{diameter of anchor rod}{bore diameter} \leq 0.85 . & ( II )\end{matrix}$$

The bore drilled for an anchoring using mortar usually has a diameter 2 millimetres greater than the diameter of the anchor rod. In the case of an anchor rod diameter of 12 millimetres, for example, the upper limit value 0.85 of condition (II) above gives a bore that is about 2 millimetres greater in diameter. The teaching according to the invention therefore involves drilling a bore of a larger diameter than customary hitherto (the upper limit value of condition (II) above gives the smallest bore diameter of the range indicated in condition (II)), that is to say providing a larger space between the anchor rod and the wall of a bore. Whereas it would actually be assumed that as narrow as possible a gap, that is to say as small as possible a space between the anchor rod and wall of the bore, ought to give better anchoring values, because the mortar, the weakest element of the anchoring arrangement, has to span only a small space, it has surprisingly been found that, in any case for crack resistance, a larger space between the anchor rod and the wall of the bore, that is to say a larger bore diameter at a given anchor rod diameter, is more advantageous, that is to say gives rise to a higher failure load.

It is not sufficient, however, simply to increase only the diameter of the bore; the strength of the mortar is also of importance to the anchoring. In condition (I) above, the strength of the mortar is taken into consideration with the bond stress. The bond stress (in N/mm²) is the force per unit surface area exerted on the mortar by the anchor rod in the event of failure at which the mortar breaks under the given conditions (especially anchor rod diameter/bore diameter). It is measured in an uncracked anchoring substrate. The bond stress is not a material constant that is dependent exclusively upon the mortar in question but it is also dependent upon the diameter of the bore and upon the anchoring depth. It is calculated in accordance with the following formula:

$$bond stress = \frac{breaking load}{bore diameter * Π * anchoring depth} [ \frac{N}{{mm}^{2}} ]$$

The term in the denominator therefore corresponds to the so-called bond surface area. It has been found that the anchoring arrangement is crack-resistant when the said conditions are observed. A criterion for crack resistance is that in a cracked anchoring substrate the anchor rod is able to take up at least 80% of the load that it can take up in an uncracked anchoring substrate before the anchoring arrangement fails, usually as a result of breakage of the mortar. The anchoring substrate is usually concrete which, when cracked, has a 0.5 millimetre wide crack passing through the bore. The bore is therefore widened by 0.5 millimetre perpendicular to a longitudinal centre plane.

The anchoring arrangement according to the invention has the advantage that it does not require a special anchor rod for crack-resistant anchoring.

The value of condition (I) is preferably relatively high and is about from 17 to 20 instead of at least 14. The range of condition (II) above is likewise limited, in that about 0.7 is selected as the upper limit value instead of 0.85. It should again be mentioned that a smaller upper limit value for condition (II) results in a larger bore diameter at a given anchor rod diameter. The minimum space between the anchor rod and the wall of the bore is increased by the indicated reduction in the range.

In a preferred construction according to the invention, the bond stress is at least 6 N/mm², preferably 10 N/mm², irrespective of condition (I), which is preferably also to be observed. The high bond stress is crucial in the respect that, irrespective of the observation of conditions (I) and (II), the use of simple anchor rods achieves significantly better holding values in a cracked anchoring substrate than would be expected from the prior art (see Eligehausen, Mallée: “Befestigungstechnik im Beton-und Mauerwerkbau”, Verlag Ernst & Sohn, 2000, especially pp 182-185). For example, in tests at high bond stresses, especially more than 10 N/mm², it was found that, irrespective of the diameter of the bore, the decline in performance in cracked concrete in comparison with uncracked concrete was unexpectedly low. Simple anchor rods are to be understood as meaning anchor rods that can be produced by simple manufacturing methods, especially by cold-forming techniques. Unlike the special anchor rods that are provided with cones, simple anchor rods generally have a significantly lower degree of shaping, with a ratio of the smallest to the largest outer diameter in the anchoring region of from 0.8 to 1, especially from 0.85 to 0.95. The anchoring region is to be understood as being the portion of the anchor rod in which the forces are substantially transferred from the anchor rod to the hardened mortar. Surprisingly, irrespective of conditions (I) and (II), it is therefore possible, even using, for example, standard threaded rods, to achieve very good holding values in a cracked anchoring substrate, which was previously considered impossible. By observing conditions (I) and (II), that behaviour can be further improved.

The anchor rod used can be of any kind; it should preferably not be smooth-walled but have surface-shaping. An anchor rod according to the invention is, for example, a reinforcing bar, for example a so-called Dywidag (ribbed) bar. A threaded rod is also a rod having surface-shaping suitable as an anchor rod for the anchoring arrangement according to the invention.

For centring the anchor rod in the bore until the mortar has hardened, a construction according to the invention provides a centring element. This may be, for example, a plastics component having resilient ribs that centre the anchor rod in the bore. It is also possible for a plastics sleeve to be placed on the anchor rod, which sleeve centres the anchor rod in the mouth of the bore. The centring element can be pre-mounted on the anchor rod and form a setting depth marker or a setting depth stop. The centring element ensures that the distance between the anchor rod and the wall of the bore remains constant around the periphery and thus the load exerted on the mortar is uniform, which is a prerequisite for high anchoring power.

One construction according to the invention provides a cutter on the forward end of the anchor rod. The cutter can be placed or screwed onto the anchor rod. The cutter is provided when there is introduced into the bore a mortar cartridge which is destroyed by the introduction of the anchor rod into the bore. The wedge tip facilitates the destruction of the mortar cartridge, effects the distribution of the mortar in the bore and improves intermixing of the mortar components. The term “cutter” is to be understood functionally rather than geometrically.

The invention will be described in greater detail below with reference to an embodiment shown in the drawings. The single FIGURE shows an axial section through an anchoring arrangement according to the invention.

The anchoring arrangement 1 according to the invention shown in the drawing has an anchor rod 2 which is anchored with mortar 3 in a bore 4 in an anchoring substrate 5. A threaded rod is used as anchor rod 2. The anchoring substrate 5 consists, for example, of concrete. The mortar 3 is preferably a two-component synthetic resin mortar, but it is possible to use other synthetic resin mortars or other mortars that fulfil the conditions of the invention, especially a sufficiently high bond stress.

A plastics sleeve 6 is placed on the anchor rod 2, the plastics sleeve having two functions: during introduction of the anchor rod 2 into the bore 4, the plastics sleeve 6 mounted on the anchor rod 2 is pressed into the mouth of the bore 4 and holds the anchor rod 2 centrally in the bore 4. The plastics sleeve 6 thus forms a centring element for the anchor rod 2. In addition, the plastics sleeve 6 forms a setting depth marker. It is placed on the anchor rod 2 at a predetermined position and is seated on the anchoring substrate 5 with a flange 7 at the mouth of the bore 4 and thereby defines the setting depth of the anchor rod 2. The plastics sleeve 6 can have an outlet opening (not shown) for excess mortar 3.

A cutter element 8 is placed or screwed onto the forward end of the anchor rod 2 located in the bore 4. The cutter element 8 has a cutter 9 extending transversely or obliquely relative to the bore 4 or alternatively has a point. The cutter 9 can in principle be formed on the forward end of the anchor rod 2. It serves for destroying a mortar cartridge and for intermixing and distributing the mortar components contained in the mortar cartridge in the bore 4. Such mortar cartridges, which usually consist of glass and contain two or more mortar components separately from one another, are known per se and need not be described here. The mortar 3 can also be introduced into the bore 3 in some other way, for example injected using an applicator gun. In that case the cutter element 8 is not required.

According to the invention, the mortar 3 has a bond stress of at least 6 N/mm², the bond stress being the breaking load, that is to say the tensile force exerted on the anchor rod 2 at which the mortar 3 breaks, per unit surface area of the bond. Further conditions of the anchoring arrangement 1 according to the invention are that the diameter of the bore divided by the diameter of the anchor rod multiplied by the bond stress is at least 14, preferably from 17 to 20. The ratio of the diameter of the anchor rod to the diameter of the bore is at least 0.4 and a maximum of 0.85, preferably a maximum of 0.7. Tests (see below) have shown that the anchoring arrangement 1 according to the invention is crack-resistant when the conditions indicated are observed. The anchoring arrangement 1 is regarded as being crack-resistant when its breaking load in a cracked anchoring substrate 5 is at least 80% of the breaking load in an uncracked anchoring substrate 5, the anchoring substrate 5 being concrete. The crack is a parallel crack which passes through the bore 4 in an axial plane and has a width of 0.5 millimetre. The bore 4 becomes wider transversely with respect to the crack by the width of the crack.

Tests with an anchor rod 2 of diameter M12 at an anchoring depth of 95 millimetres and a 0.5 millimetre wide parallel crack yield the values listed in the table below:
Anchor rod: threaded rod M12
Anchoring depth: 95 mm
Mortar: fischer FIS EM 390 S
0.5 mm parallel crack

| | Breaking | Bond stress | Bore Ø/anchor rod Ø × | Anchor rod | |
|---|---|---|---|---|---|
| Bore Ø | load | (bore Ø) | bond stress | Ø/bore Ø | Remarks |
| 14 | 36.0 kN | 8.6 N/mm² | 10.1 N/mm² | 0.86 | not crack- |
| | | | | | resistant |
| 16 | 64.0 kN | 13.4 N/mm² | 17.9 N/mm² | 0.75 | crack-resistant |
| 18 | 71.0 kN | 13.2 N/mm² | 19.8 N/mm² | 0.67 | crack-resistant |
| 20 | 66.0 kN | 11.1 N/mm² | 18.4 N/mm² | 0.60 | crack-resistant |
| 22 | 71.5 kN | 10.9 N/mm² | 20.0 N/mm² | 0.55 | crack-resistant |
| 18 | 48.0 kN | 8.9 N/mm² | 13.4 N/mm² | 0.67 | blown out 2x |
| | | | | | not crack- |
| | | | | | resistant |

The table shows that larger diameters of bore tend to result in crack resistance in accordance with the above criteria. Cleaning the bore also has a crucial effect on the anchoring, as shown by the last line of the table where the bore had been blown out twice using a manual blow-out device. In the other tests, the bore had been better cleaned with compressed air and/or by brushing out and thus the breaking load was considerably increased.

1-7. (canceled)

8. An anchoring arrangement, comprising an anchor rod which is to be anchored with a mortar in a bore in a cracked anchoring substrate, said anchor rod has an anchoring region configured as a region provided with an element selected from the group consisting of a standard thread, a knurling and a surface-shaping of a reinforcing bar, said anchoring region of said anchor rod having a smallest outer diameter and a largest outer diameter with a ratio of the smallest outer diameter to the largest outer diameter being from 0.8 to 1, wherein following conditions are fulfilled:
$$\begin{matrix}\frac{bore diameter}{diameter of anchor rod} * bond stress \geq 14 \frac{N}{{mm}^{2}} and & ( I ) \\ 0.4 \leq \frac{diameter of anchor rod}{bore diameter} \leq 0.7 . & ( II )\end{matrix}$$

9. The anchoring arrangement as defined in claim 8 wherein the ratio of the smallest outer diameter to the largest outer diameter in the anchoring region of the anchor rod is from 0.85 to 0.95.

10. An anchoring arrangement as defined in claim 8, wherein a following condition is fulfilled:
$$\frac{bore diameter}{diameter of anchor rod} * bond stress = 17 - 20 \frac{N}{{mm}^{2}} .$$

11. An anchoring arrangement as defined in claim 8, wherein the bond stress is
≧10 N/mm²

12. An anchoring arrangement as defined in claim 8, wherein said anchor rod is configured as a rod having a surface-shaping.

13. An anchoring arrangement as defined in claim 8, wherein said anchor rod is configured as a threaded rod.

14. An anchoring arrangement as defined in claim 8; and further comprising a centering element which centers said anchor rod in the bore.

15. An anchoring arrangement as defined in claim 8, wherein said anchor rod has a cutter.

16. A method of using an anchor rod in a cracked anchoring substrate with a mortar, comprising the steps of providing in the anchor rod an anchoring region configured as a region having an element selected from the group consisting of a standard thread, a knurl, and a surface-shaping of a reinforcing bar; selecting a ratio of a smallest to a largest outer diameter in said anchoring region of said anchor rod to be from 0.8 to 1; and selecting a bond stress greater than 5.6 N/mm².

17. A method as defined in claim 16, wherein said selecting the ratio includes selecting the ratio of the smallest to the largest outer diameter in the anchoring region of the anchor rod to be from 0.85 to 0.95.

18. A method as defined in claim 16; and further comprising selecting the bond stress greater than 10 N/mm².
